(19) United States
(12) Patent Application Publication
(10) Pub. No.: US 2007/0189509 A1
(43) Pub. Date: Aug. 16, 2007

(54) DATA PATH IDENTIFICATION AND ANALYSIS FOR DISTRIBUTED APPLICATIONS

(76) Inventors: Daniel M. Foody, Wellesley, MA (US); Michael Clements, Eastsound, WA (US); Jean-Francois Cloutier, Laval (CA)

Correspondence Address: FENWICK & WEST LLP, SILICON VALLEY CENTER, 801 CALIFORNIA STREET, MOUNTAIN VIEW, CA, 94041, US

(21) Appl. No.: 11/674,492

(22) Filed: Feb. 13, 2007

Related U.S. Application Data
(60) Provisional application No. 60/773,284, filed on Feb. 13, 2006.
(60) Provisional application No. 60/789,305, filed on Apr. 4, 2006.

(51) Int. Cl. H04K 1/00

(52) U.S. Cl. 380/2

(57) ABSTRACT

A method for identifying a data processing path in a distributed computing network is disclosed. Initially, a call from a local device to a remote device is initiated. A path identifier is then generated which uniquely identifies the flow of data from the local device to the remote device. The generated path identifier is then associated with the call and data associated with the initiated call is stored. The generated path identifier is then stored and associated with the data associated with the initiated call. Additionally, the generated path identifier can also be used to transmit additional data, not essential to the call, along the identified path.

### CROSS REFERENCE TO RELATED APPLICATIONS

This application claims priority from U.S. Provisional Application No. 60/773,284, filed Feb. 13, 2006, and U.S. Provisional Application No. 60/789,305, filed Apr. 4, 2006, which are all incorporated by reference herein in their entirety

### BACKGROUND

1. Field of Art

The present invention generally relates to the field of distributed applications, and more specifically, to identifying and analyzing data paths in distributed applications.

2. Description of the Related Art

Advances in networking technology allow application processing to be distributed among multiple networked devices. In such distributed applications, multiple computers act as servers to provide services for client computers. Each server provides one or more services, or portions of a service, and may act as a client receiving services from another server. Thus, multiple servers interact with each other to perform a business application, with each server providing a portion of the overall business application.

Recently, application platforms such as J2EE, Microsoft®.NET and database application servers, have allowed a server to run multiple networked applications to provide multiple services, or to provide portions of multiple distributed applications. These platforms allow Service Oriented Architecture (SOA) and Enterprise Service Bus (ESB) implementations where applications, such as business processes or other high level constructs, use multiple individual servers to provide a service. This allows many different servers to be integrated into a single cohesive unit. The heterogeneous services offered by such a cohesive unit span multiple servers or computer systems, which can be in multiple locations. In addition, the distribution of these servers may not be determined until application processing begins.

While this distributed computing increases the type and amount of services provided to end-users, dividing application processing among multiple computers or computer networks complicates application analysis and optimization. Although conventional techniques record data received by a server and transmitted from a server, these techniques do not correlate received data with the corresponding transmitted data. Further, existing distributed applications merely transmit the data used by the application from server to server. Although this server to server data flow also describes the control flow of the distributed application, indicating the order in which portions of an overall business process are performed, these existing methods do not identify how data flows from computer to computer during processing, but merely record bulk data indicating all data received by and transmitted from the networked computers.

From the above, there is a need for a system and process to identify and analyze how data flows through a distributed application.

### SUMMARY

The present invention overcomes the deficiencies and limitations of the prior art by providing an apparatus and method for identifying a data path through a distributed computing network and a method for analyzing the identified data path. A flow of data through an apparatus, which performs distributed computing tasks, such as a distributed business application, is uniquely identified. In an embodiment, the apparatus comprises an application for processing input data and generating output data. An intercept module is adapted to communicate with the application and intercepts a portion of the input data and a portion of the output data. In an embodiment, the intercept module comprises an inbound intercept module and an outbound intercept module. The inbound intercept module intercepts a portion of the input data and transmits the input data to the application. The outbound intercept module intercepts a portion of the output data from the application. An agent module is adapted to communicate with the intercept module. The agent module stores the data intercepted by the intercept module and generates a path identifier uniquely identifying the intercepted input data and the intercepted output data corresponding to the input data. In an embodiment, the agent module generates the path identifier by applying a hash function to a portion of the intercepted input data and the intercepted output data corresponding to the input data.

In an embodiment, the data processing path identifies a call which transmits data to a remote device. A path identifier uniquely identifying the data processing path corresponding to the call is then generated and associated with the identified call. Data associated with the identified call is then stored and the generated path identifier is stored. The stored path identifier is then correlated with the stored data associated with the identified call.

In an embodiment, data is added to an identified data processing path. A data path and a flow field are selected at an administrative node. The flow field comprises data to be transmitted throughout the distributed computing network using the selected data path. The selected flow field is then transmitted from the administrative node to a first server node for transmission to additional server nodes. In an embodiment, a path identifier uniquely identifying the data path is then generated at the administrative node and is also transmitted from the administrative node to the first server node.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF DRAWINGS

The invention is illustrated by way of example, and not by way of limitation in the figures of the accompanying drawings in which like reference numerals are used to refer to similar elements.

FIG. 1 is a block diagram of a distributed computing network according to one embodiment of the invention.

FIG. 2 is a block diagram of a server node for identifying data paths in a distributed computing network according to one embodiment of the invention.

FIG. 3 is a trace diagram of a method for identifying a data path in a distributed computing network according to one embodiment of the invention.

FIG. 4 is a trace diagram of a method for retrieving data associated with a data path from a distributed computing network according to one embodiment of the invention.

FIG. 5 is a trace diagram of a method for transmitting additional data through a distributed computing network using a data path according to one embodiment of the invention.

FIG. 6 is a flow chart of a method for using a data path to analyze a business process according to one embodiment of the invention.

FIG. 7 is a block diagram of a business process according to one embodiment of the invention.

FIG. 8 is an example user interface for analyzing a business process according to one embodiment of the invention.

### DETAILED DESCRIPTION

A method for identifying and modifying data paths in a distributed computing network is described, for purposes of explanation; numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will be apparent from the description below. In addition, the present invention is not described with reference to any particular programming language. It will be appreciated that a variety of programming languages may be used to implement the teachings of the invention as described herein.

In the following, interactions between applications and/or server nodes 110 include messages, events, transactions, calls or invocations between one application 230 and/or server node 110 and one or more other applications 230 and/or server nodes 110. An interaction, or call, between one server node 110 and a different server node 110 can comprise a request and a reply or a request.

System Architecture

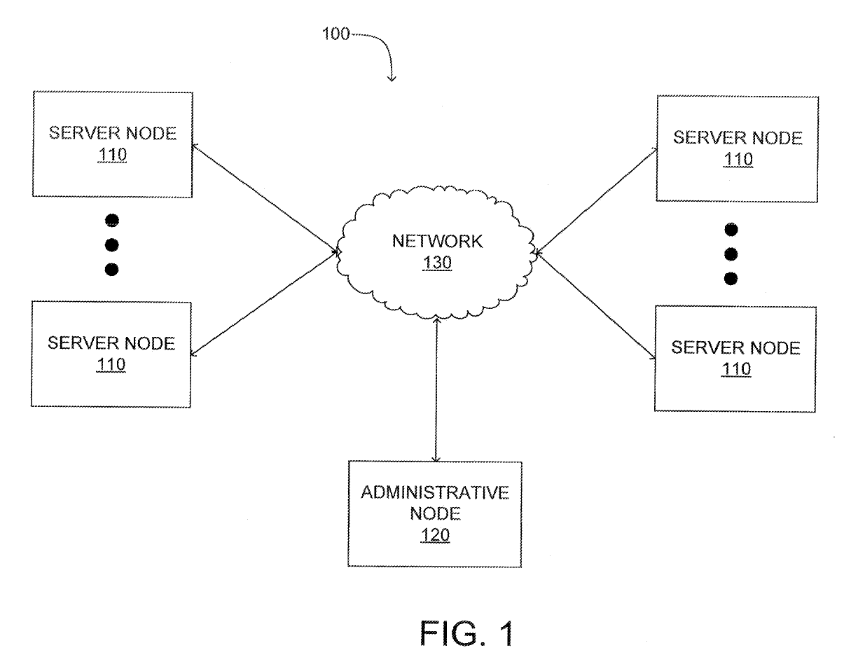

FIG. 1 illustrates one embodiment of a system 100 for distributed computing according to the present invention. The system 100 comprises a plurality of server nodes 110 and an administrative node 120. In an embodiment, system 100 further comprises a network 130 allowing the server nodes 110 and administrative node 120 to communicate with each other. Alternatively, the server nodes 110 and the administrative node 120 directly communicate with each other in a peer-to-peer environment.

Server nodes 110 each include computing capabilities and data communication capabilities. Multiple server nodes 110 are used to implement networked computing tasks, with each server node 110 performing a portion of the computing tasks. In an embodiment, a server node 110 receives input related to the networked computing tasks, performs operations on the received input to generate an output and transmits the output to a different server node 110 where additional networked computing tasks are executed. In an embodiment, an operation code identifies each network computing task performed by the server node 110. Thus, multiple server nodes 110 perform portions of the networked computing tasks to achieve a desired overall result, such as execution of a business process.

In an embodiment, system 100 uses calls to transmit data between or among multiple server nodes 110. Each data transmission between server nodes 110 comprises a call. Because multiple server nodes 110 perform the networked computing task, multiple calls are used. A path provides a snapshot of the call stack from the current execution point to the beginning of the networked computing task. Hence, a path illustrates the flow of data between and among the server nodes 110 from the beginning of the processing to the current execution point. The path identifies data received by a server node 110 and data transmitted by the server node 110 after processing the received data, indicating the input and output data of the server node 110. In an embodiment, a data path is predefined to specify the data transmission between or among server nodes 110.

Administrative node 120 also includes computing capabilities and data communication capabilities. The administrative node 120 monitors, controls, examines and/or evaluates the networked computing task. In an embodiment, the administrative node 120 retrieves and/or monitors data from multiple server nodes 110 to evaluate performance of the networked computing task. In an embodiment, the administrative node 120 calculates performance statistics, such as execution time, delay time or other suitable metrics, based on data from the server nodes 110. Alternatively, the administrative node 120 additionally provides data or instructions to the server nodes 110 altering server node 110 operation or reconfiguring the data path through the server nodes 110. In another embodiment, the administrative node 120 specifies data for transmission between or among the server nodes 110 using a data path.

In an embodiment, the network 130 is used to transmit information between or among the server nodes 110 and/or the administrative node 120. The network 130 may comprise a conventional wireless data communication system, for example, general packet radio service (GPRS), IEEE 802.11 (or WiFi), IEEE 802.16 (or WiMax), Bluetooth, or any other suitable wireless communication system. Alternatively, the network 130 may comprise a conventional wired data communication system, such as Ethernet, digital subscriber line (DSL), integrated services digital network (ISDN), or any other suitable wired communication system. In an embodiment, the network 130 comprises a combination of a wireless communication system and a wired communication system. Alternatively, the network 130 is replaced by a peer-to-peer configuration where the server nodes 110 and the administrative node 120 directly communicate with each other.

In another embodiment, the server nodes 110 comprise different modules on a single device, with different server nodes 110 performing different computing tasks (e.g. different applications, different processes, different threads, etc.). The network 130 enables the different server nodes 110 to use inter-process communication (IPC) to share data through techniques such as sockets, simple object access protocol (SOAP), extensible markup language-remote procedure call (XML-PRC), distributed computing environment (DCE) or other suitable IPC techniques. Thus, a single device comprises multiple server nodes 110 which perform different computing tasks and use network 130 to communicate data between the different tasks, allowing the single device to perform different types of computing tasks or perform different parts of a computing task in parallel.

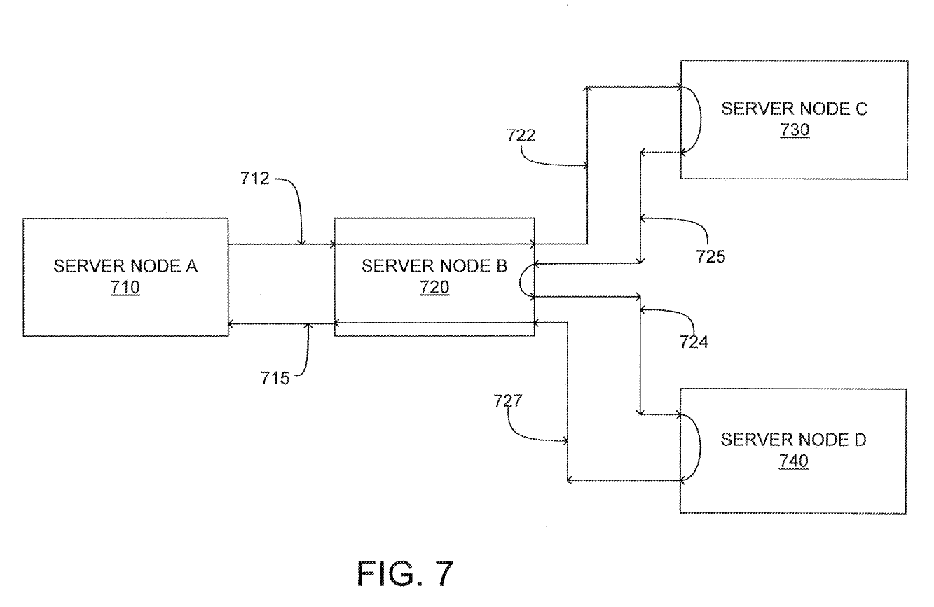

FIG. 7 is a block diagram illustrating a distributed business process executed by a distributed computing system 100, according to an embodiment of the invention. For purposes of illustration, FIG. 7 shows four server nodes, server node A 710, server node B 720, server node C 730 and server node D 740; however, the system 100 may include any number of server nodes 110.

A business process comprises a collection of activities, or processes, designed to produce a specific output. In a distributed computing system 100, multiple server nodes 110 perform the activities, or processes, comprising the business process. As multiple server nodes 110 execute the business process, data used to execute the business process is transmitted between server nodes 110 using calls. A call comprises a transmission of data between server nodes 110; thus, execution of a business process involves transmitting multiple calls between the server nodes 110 which process the data.

In the example of FIG. 7, server node A 710 initiates a business process. In an embodiment, a user or a software module initiates the business process by requesting data provided by the business process. Server node A 710 then transmits the request to server node B 720 using call 712. Thus, call 712 transmits data from server node A 710 to server node B 720 requesting execution of a business process and data for executing the business process.

Upon receiving call 712, server node B 720 uses the data from call 712 to begin executing the business process identified by call 712. The output data, or a portion of the output data, from server node B 720 is then transmitted to server node C 730 via call 722. Server node C 730 then processes the data from call 722, continuing execution of the business process. Alternatively, server node B 720 transmits data to both server node C 730 via call 722 and server node D 740 via call 724 so server node C 730 and server node D 740 execute parts of the business process in parallel. Server node C 730 uses call 725 to transmit the output of the processing back to server node B 720. Server node B 720 then continues executing the business process by processing data from call 725.

Server node B 720 then transmits the results of the data processing to server node D 740 via call 724. Server node D 740 then processes the received data and transmits the resulting output data back to server node B using call 727. Server node B 720 completes the business process by processing the data received from call 727 and transmits the resulting data back to server node A 710 using call 715.

Thus, the distributed computing system 100 uses a sequence of calls 712, 722, 724, 725, 727 and 715 to transmit data between server node A 710, server node B 720, server node C 730 and server node D 740 to execute a business process. Server node A 710, server node B 720, server node C 730 and server node D 740 each perform a portion of the processing used to execute the business process.

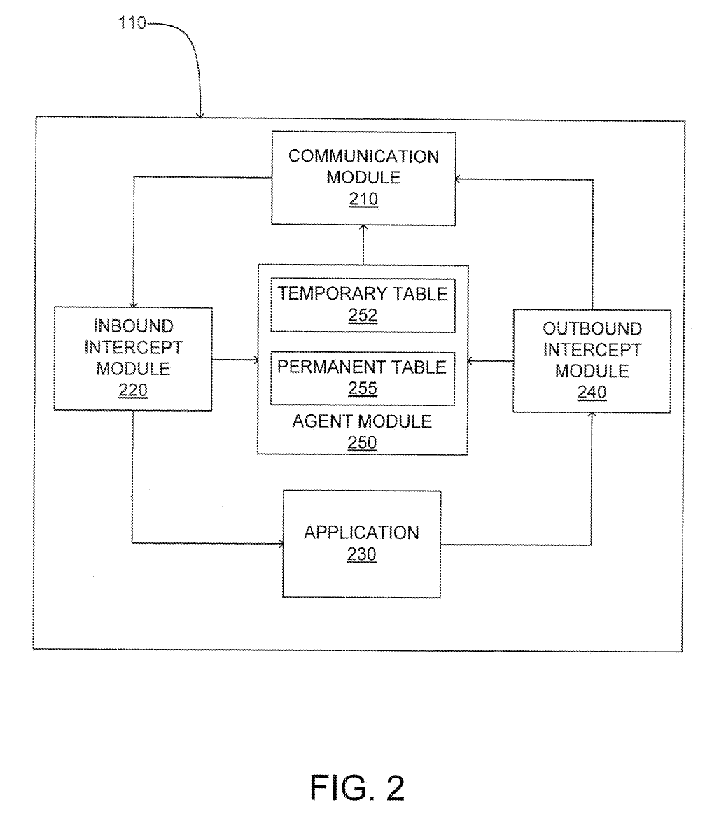

FIG. 2 is a block diagram illustrating components of a server node 110, according to an embodiment of the invention. Those of skill in the art will recognize that other embodiments can include different and/or additional features and/or components than the ones described here. Each server node 110 comprises a communication module 210, an inbound intercept module 220, an application 230, an outbound intercept module 240, and an agent module 250.

The communication module 210 enables a server node 110 to communicate with network 130, the administrative node 120 and/or other server nodes 110. In an embodiment, the communication module 210 comprises a transceiver such as for infrared communication, Bluetooth communication, 3G communication, radio frequency communication, or any other wireless communication technique. In an alternative embodiment, the communication module 210 comprises a conventional wired connection, such as Ethernet, USB, etc. or other wired communication technique. Alternatively, the communication module 210 comprises both a wired connection and a transceiver. The communication module 210 allows data files, commands and/or information to be distributed using network protocols, such as Transmission Control Protocol (TCP), Internet Protocol (IP), Hypertext Transmission Protocol (HTTP), or other protocols capable of communicating data or information.

The inbound intercept module 220 is inserted into the flow of data between the communication module 210 and the application 230 and records data, or characteristics of data, that is input to the application 230. Calls from other server nodes 110 are intercepted by the inbound intercept module 210 which extracts data from the call without disrupting the data flow into the application 230. The operations performed by the application 230 are unaffected by the inbound intercept module 220, but the inbound intercept module 220 records data or other information, such as statistics, describing the call received by the communication module 210. For example, the inbound intercept module 220 extracts data such as call initiation time, the server node 110 initiating the call, the application 230 initiating the call, a unique identifier of the call, a description of the call path, a logical thread associated with the call or any other suitable data. As the call is transmitted from the communication module 210 to the application 230, inbound intercept module 220 extracts data from the call and transmits the extracted data to the agent module 250.

The outbound intercept module 240 is inserted into the flow of data between the communication module 210 and the application 230 and records the output data of application 230 before the output data reaches the communication module 210. Essentially, the outbound intercept module 240 intercepts a call from the local application 230 to applications 230 on one or more different server nodes 110. The operations performed by the application 230, and the data transmission by the communication module 210, are unaffected by the outbound intercept module 240 which extracts statistics and information associated with the application output. For example, the outbound intercept module 240 extracts information such as the destination server node 110, the destination application 230, the output data generation time, a unique identifier of the call to another server node 110, a description of the data path, a logical thread associated with the call or any other suitable data. In an embodiment, the outbound intercept module 240 also extracts from the output data information indicating the output data is responsive to a received call. The data recorded by the outbound intercept module 240 is then transmitted to the agent module 250 while the application 230 output data is communicated to the communication module 210 for transmission to other server nodes 110. In an embodiment, a single intercept module includes the inbound intercept module 220 and the outbound intercept module 240.

In an embodiment, the inbound intercept module 220 and/or the outbound intercept module 240 comprise a virtual layer in a protocol stack which extends the protocol stack so all interactions, or calls, pass through the inbound intercept module 220 and/or the outbound intercept module 240. In an embodiment, a protocol stack implementing the Open System Interconnect (OSI) model, or another conventional protocol model, is used. Alternatively, the inbound intercept module 220 and/or the outbound intercept module 240 replace the elements in the protocol stack and forward received call data to elements corresponding to those originally found in the protocol stack after intercepting call data. The set of elements corresponding to those originally found in the protocol stack may be defined through configuration information or through start-up time software configuring independently of the application 230. In another embodiment, where an isolation mechanism, such as Java Remote Method Invocation (RMI) or the Open Source Foundation Distributed Computing Environment (OSF DCE), is used for communication between applications 230 and server nodes 110, the inbound intercept module 220 and/or the outbound intercept module 240 comprises a subset of classes or application processing interfaces (APIs) with a higher precedence for loading. When these classes and/or APIs are invoked as part of a call, the inbound intercept module 220 and/or the outbound intercept module 240 are loaded, and data is intercepted then delegated to the original class or API for processing by the application 230.

The application 230 performs a network computing task or a portion of a network computing task. The application 230 allows the server node 110 to access and modify data that is locally stored or received from another server node 110. In an embodiment, the application 230 uses and modifies data files without direct user input. Alternatively, the application 230 receives input from a user and processes data responsive to the user input. Typically, the server node 110 contains a number of different applications 230 that each perform different functions (such as data retrieval, data storage, data forwarding, data manipulation, data analysis or other suitable functions), but for simplicity, an embodiment with a single application 230 is described herein.

The agent module 250 receives data from the inbound intercept module 220 and the outbound intercept module 240 and generates an aggregate listing of the calls received by, and transmitted from, the server node 110 by processing the received data. In an embodiment, the agent module 250 further processes the received data to generate additional data, such as a path name, a path identifier, statistics describing call processing by the server node 110 or other suitable data. Alternatively, the agent module 250 compresses the received data to increase the amount of data stored, or to reduce the bandwidth for transmission of the stored data through communication module 210. In another embodiment, the agent module 250 applies filter parameters to sort the stored data or to determine a subset of the received data for storage.

In an alternative embodiment, the agent module 250 comprises a processor (not shown) adapted to communicate with a hard disk drive, a flash memory device or another suitable memory device or mass storage device. Further, the agent module 250 can be a volatile storage device, a non-volatile storage device or a combination of a non-volatile storage device and a volatile storage device. In an embodiment, the agent module comprises a processor configured to process input data and to generate output data and may comprise various computing architectures including a complex instruction set computer (CISC) architecture, a reduced instruction set computer (RISC) architecture, or an architecture implementing a combination of instruction sets. A single processor or multiple processors can be used by the agent module 250 to generate the output data. In an embodiment, the processor applies a compression algorithm to the received data to reduce the storage necessary for the data.

In an embodiment, the agent module 250 comprises a temporary table 252 and a permanent table 255. The temporary table 252 stores call data received from the inbound intercept module 220 and stores the call data into an identified slot in a memory device. In one embodiment, the temporary table 252 uses a server node 110 identifier, such as the service provided by the server node 110 and/or the operation requested by the received call, to identify the slot including the stored data. When the agent module 250 receives data from the outbound intercept module 220 indicating an inbound call has been processed and the resulting output is ready for transmission, the slot in the temporary table 252 corresponding to the call data is stored in a memory location corresponding to the permanent table 255 and removed from the temporary table 252. In an embodiment, when the slot is stored in the permanent table 255, additional data is stored such as the result of the call, response time or other data describing the call processing. Further, when the slot is stored in the permanent table 255 a path identifier associated with the data is also stored.

In an embodiment, the temporary table 252 stores data describing calls currently processed by the application 230 while the permanent table 255 stores data describing calls that have been processed by the application 230. Alternatively, the agent module 250 comprises a permanent table 255 storing data from the input intercept module 220 describing calls being processed and updates the stored data with data from the output intercept module 240 when call processing is completed. Hence, the agent module 250 stores a rolling log of the calls received by, processed by and transmitted from the server node 110.

As described above, the agent module 250 tracks and stores the calls received by and transmitted from the server node 110; however, in other embodiments the agent module 250 provides additional functionality. In an alternative embodiment, the agent module 250 temporarily stores all calls to and from a server node 110 then filters the stored data to select a subset for permanent storage. For example, the agent module 250 temporarily stores the calls received by and transmitted form the server node 110 then filters the stored data to permanently store calls including a particular data value (e.g., a product name, an originating server node 110, an originating time, etc.). Alternatively, the agent module 250 applies a filter parameter, or a set of filter parameters, to the calls received by and transmitted from the server node 110 to store a subset of calls matching the filter parameter or filter parameters rather than the complete set of calls. In yet another embodiment, the agent module 250 stores a rolling log of the calls received by, processed by and transmitted from the server node 110 then applies a filter parameter, or filter parameters, to sort the stored calls.

The agent module 250 is adapted to communicate with the communication module 210 and transmits data associated with calls processed by the server node 110 to the communication module 210 for transmission to the administrative node 120 or another server node 110. In an embodiment, the agent module 250 transmits data through the communication module 210 responsive to requests from the administrative node 120. Alternatively, the agent module 250 continuously transmits data using the communication module 210 or transmits data according to a specified schedule. In another embodiment, the agent module 250 compresses the data before transmitting it to the communication module 210 to reduce the bandwidth necessary for data transmission.

As described above, the agent module 250 resides on the same server node 110 as the inbound intercept module 220 and the outbound intercept module 240. However, in an alternative embodiment, the agent module 250 resides on a different server node 110, allowing multiple server nodes 110 to share a single agent module 250. The communication module 210 then transmits data from the inbound intercept module 220 and outbound intercept module 240 of a server node 110 to the remote agent module 250 which maintains a log of the input to and output from multiple server nodes 110. This allows input data and output data for multiple server nodes 110 to be accessed from a central location.

System Operation

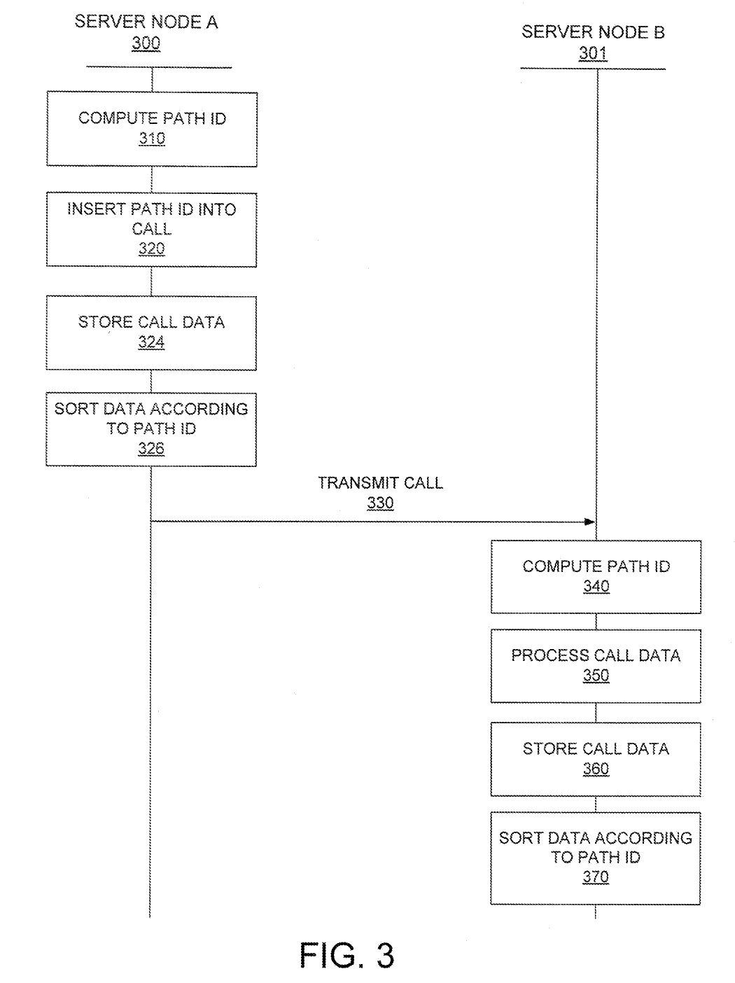

FIG. 3 illustrates a trace diagram of a method for identifying a data path in a distributed computing network according to an embodiment of the invention. For purposes of illustration, FIG. 3 shows a distributed computing network comprising two server nodes 110, server node A 300 and server node B 301; however, the distributed computing network may include any number of server nodes 110. Those of skill in the art will recognize that other embodiments can perform the steps of FIG. 3 in different orders. Moreover, other embodiments can include different and/or additional steps than the ones described here.

Initially, server node A 300 computes 310 a path identifier associated with the current call. The path identifier uniquely identifies an ordered list of service operations showing the sequence of operations performed by the system 100. In an embodiment, a combination of operation identifier and node name (e.g. a Uniform Resource Locator identifying the server node 110) is used to generate the path identifier. The path identifier is computed 310 so that different server nodes 110 can generate the same path identifier from received data.

In an embodiment, a hash algorithm, such as an MD5 hash, is applied to data associated with the call, with the result of the hash algorithm used as the path identifier. For example, the path identifier is calculated 310 by applying a hash algorithm to a string comprising a delimiter, an operation identifier and a server node 110 name. In an embodiment, computation 310 of the path identifier also includes a parent path identifier specifying the path originating the call, so the path identifier is computed 310 by applying a hash algorithm to a delimited string including the parent path identifier, an operation identifier and the server node 110 name. If there is no path identifier originating the call (e.g., the server node 110 originates the call), a constant default value is used for the parent path identifier. Using the path identifier removes the need to implement a uniform naming convention for server nodes 110 by providing a value that identifies the path of data between server nodes 110 independent of naming conventions.

The computed 310 path identifier is then inserted 320 into a call to server node B 301. In an embodiment, the path identifier is inserted 320 into a header, such as the header of a SOAP message, of the call. Alternatively, the path identifier is inserted into a predefined location in the call, or in another ascertainable location in the call. In an embodiment, the server nodes 110 used to execute a business process are dynamically allocated, so the data path through the system 100 is not determined until the business process is executed. Inserting the path identifier into the call allows the call to be tracked from server node 110 to server node 110 without advance knowledge of the server nodes 110 used for processing.

In an alternative embodiment, the path identifier is locally stored on server node A 300 rather than being inserted 320 into the call. Server node A 300 stores the path identifier and a call identifier associated with the corresponding call. This associates the computed 310 path identifier with the corresponding call, allowing multiple related calls to be associated with a path identifier. For example, when server node A 300 comprises an agent module 250 shared between multiple server nodes 110, server node A 300 stores the computed 310 path identifier and associates the path identifier with calls to and from the server nodes 110 sharing the agent module 250.

Data associated with the call is then stored 324 in the agent module 250 of server node A 300 and sorted 326 according to the path identifier. Although shown in FIG. 3 as occurring in series, server node A 300 can store 324 and/or sort 326 the call data in parallel with inserting 320 the path identifier into the call. By storing 324 and sorting 326 according to path identifier the agent module 250 maintains a record of the calls transmitted from server node A 300 which are readily accessible using the path identifier. This storage scheme allows data associated with a particular path to be quickly retrieved. In another embodiment, server node A 300 transmits the call data and path identifier to an administrative node 120 after inserting 320 the path identifier into the call and storing 324 the call data.

After storing 324 and sorting 326 the call data, server node A 300 transmits 330 the call to server node B 301. In an embodiment, server node A 300 uses a SOAP message to transmit 330 the call data to server node B 301 with the computed 310 path identifier included in the SOAP message header. Upon receiving the call, server node B 301 computes 340 a path identifier using the received call. Server node B 301 uses the path identifier computed 310 by server node A 300 as the parent path identifier when computing 340 the path identifier.

After computing 340 the path identifier, the call data is processed 350 by server node B 310 to create output data for subsequent processing by another server node 110. The call data, including the output, or characteristics of the output, from the call processing 350, is then stored 360 in the agent module 250 of server node B 301 along with the computed 340 path identifier. The stored 360 data is then sorted 370 according to path identifier to simplify access to data associated with different paths. Although shown in FIG. 3 as occurring in series, server node B 301 can store 360 and/or sort 370 the call data in parallel with processing 350 the call data. The agent module 250 of server node B 301 then includes both input data received by server node B 301 and output data generated by server node B 301 associated with the computed 340 path identifier. This allows the path identifier to retrieve both input data and output data corresponding to the input data from server node B 301. Thus, the path identifier simplifies access to the flow of data into and out of a server node. In another embodiment, server node B 301 transmits the call data and path identifier to an administrative node 120 after storing 360 the call data.

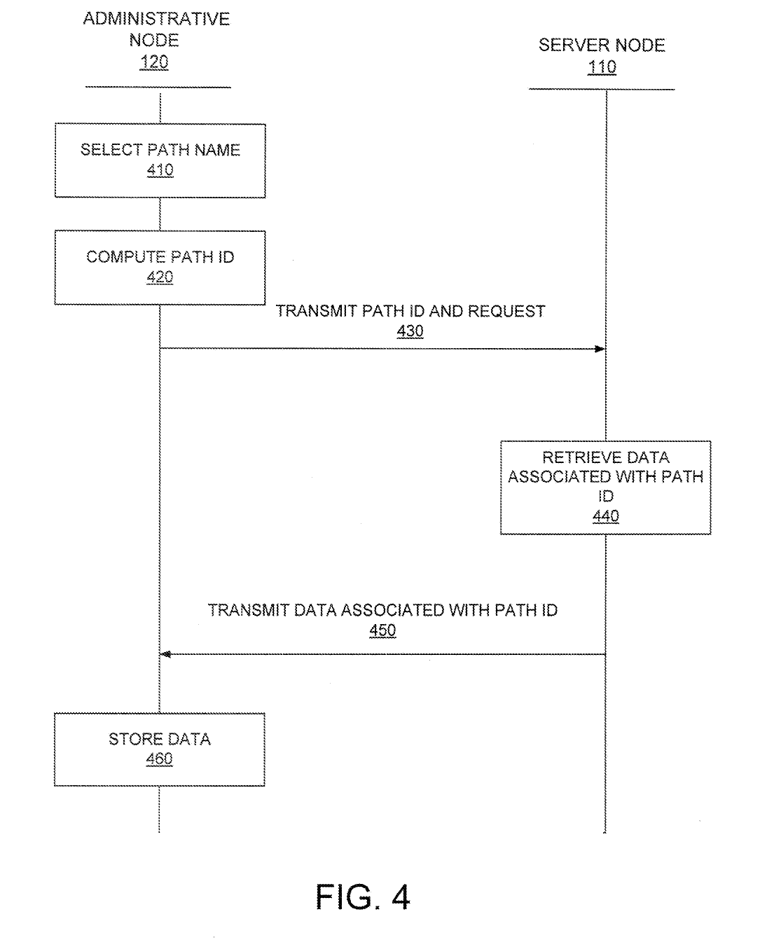

FIG. 4 is a trace diagram of a method for retrieving data associated with a data path in a distributed computing network according to an embodiment of the invention. For purposes of illustration, FIG. 4 shows retrieval of data from a single server node 110; however, the administrative node 120 retrieves data from a plurality of server nodes 110. In an embodiment, the administrative node 120 comprises a part of one of the server nodes 110. Alternatively, the administrative node 120 comprises a dedicated computing device, such as a server node 110, for analyzing path data. Those of skill in the art will recognize that other embodiments can perform the steps of FIG. 4 in different orders. Moreover, other embodiments can include different and/or additional steps than the ones described here.

Initially, the administrative node 120 selects 410 a path name for analysis. In an embodiment, a user selects 410 the path name for analysis by selecting a path name from a list, manually entering a path name or another suitable form of user data entry. Using the path name for selection 410 allows the path to be identified by a recognizable and/or descriptive name. Alternatively, a software module running on the administrative node 120 selects 410 the path name or path identifier for analysis.

The path identifier corresponding to the selected 410 path name is then computed 420. Computing 420 the path identifier from the selected 410 path name enables multiple server nodes 110 to identify the path being analyzed, independent of the naming convention for server nodes 110 or paths. This allows descriptive, human-readable path names to be displayed on the administrative node 120, while also uniquely identifying each path for accurate path tracing and identification. In an embodiment, the administrative node 120 computes 420 the path identifier using methods similar to those described above in conjunction with FIG. 3.

A request for information including, or associated with, the computed 420 path identifier is then transmitted 430 to the server node 110, which retrieves 440 data associated with the path identifier. In an embodiment, server node 110 accesses the local agent module 250 and searches for stored data associated with the computed 420 path identifier. The data associated with the path identifier is then transmitted 450 from the server node 110 to the administrative node 120. The administrative node 120 then stores 460 the data for subsequent analysis and/or presentation. Thus, the administrative node 120 receives data from the server node 110 associated with the selected 410 path name, allowing analysis of the selected 410 path name. In an embodiment, the administrative node 120 sorts the stored 460 data as part of the analysis or in addition to the analysis.

By transmitting a path identifier to server node 110, and additional server nodes 110, the administrative node 120 can analyze a particular route in which data travels between or among server nodes 110. This path-specific data allows the data path to be refined or server nodes 110 along the path to be modified to improve data processing along the analyzed path.

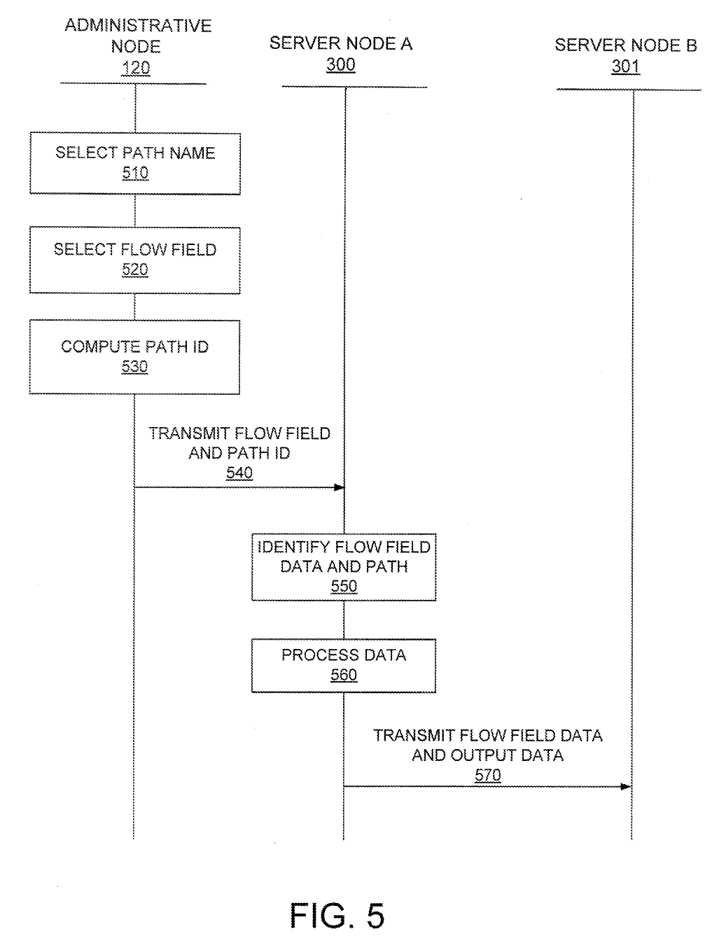

FIG. 5 is a trace diagram of a method for transmitting additional data through a distributed computing network using a data path according to an embodiment of the present invention. For purposes of illustration, FIG. 5 shows a distributed computing network comprising two server nodes 110, server node A 300 and server node B 301, and an administrative node 120; however, the distributed computing network may include any number of server nodes 110 and/or administrative nodes 120. Those of skill in the art will recognize that other embodiments can perform the steps of FIG. 5 in different orders. Moreover, other embodiments can include different and/or additional steps than the ones described here.

Initially, a path name is selected 510 for inclusion of additional data. In an embodiment, a user selects 510 the path name to include additional data by selecting a path name from a list, manually entering a path name or another suitable form of user data entry. Using the path name for selection 410 allows the user to choose the path based on a recognizable and/or descriptive name. Alternatively, a software module running on the administrative node 120 selects 410 the path name or directly selects the path identifier.

A flow field 520 is then selected by a user, by a software process or by another suitable method. The flow field 520 specifies data that is transmitted along the path in addition to the data required by the server nodes 110 to compute the distributed application. For example, the flow field 520 identifies a time stamp indicating when the call was initiated, a time stamp indicating when a processing event occurs, a time stamp indicating when data was transmitted or received, an identifier of the server node 110 originating the call, data entered by a user, a data field from the call, additional data to optimize or modify the distributed application or other suitable data. Data identified by the flow field 520 is not necessarily required by the server nodes 110 to complete the distributed application, but is transmitted from server node 110 to server node 110 along with the required data. This increases the availability of the flow field data by allowing it to be accessed from any server node 110 along the data path rather than requiring access from a particular server node 110 or central storage location.

In an embodiment, after selecting 520 the flow field, a path identifier is computed 530 and transmitted 540, along with the flow field, to server node A 300. The path identifier uniquely specifies the path which includes the additional flow field data. Server node A 300 then identifies 550 the flow field data and the corresponding path. Alternatively, the flow field is transmitted 540 to server node A 300 while the computed 530 path identifier is locally stored on the administrative node 120 and server node A 300 separately identifies the appropriate path identifier.

Server node A 300 then processes 560 data to perform part of a distributed application. In an embodiment, server node A 300 receives the data to be processed 560 from a server node 110 rather than the administrative node 120. Alternatively, server node A 300 receives the data to be processed 560 from local user input or a software process running on server node A 300. In an embodiment, the processed 560 data is distinct from the flow field data. Alternatively, the flow field data is processed 560 to produce output data, while a copy of the original flow field data remains unmodified and transmitted along the identified 550 data path.

The processed 560 data is then transmitted 570, along with the flow field data, to server node B 301 where additional portions of the distributed application are performed. In an embodiment, the flow field data is included in the required data as an additional field, or as header data. Alternatively, the flow field data is transmitted 570 in a separate call associated with the call including the required data. Thus, server node B 301 receives the flow field data as well as output data from server node A 300 for use in the distributed application portion performed by server node B 301. As the flow field data is transmitted from server node A 300 to server node B 301 along with the data used in the distributed application, the flow field data is accessible from server node A 300, server node B 301 or additional server nodes 110 included in the selected 510 path.

Transmitting the identified 550 flow field data along a path allows the flow field data to be used for path optimization, analysis, or modification of the distributed application. For example, the flow field data can transmit data which supplements the distributed application and improves application processing. Flow field data allows data to be transmitted 550 to multiple server nodes 110 without requiring identification of the individual server nodes 110, simplifying the modification or optimization of distributed applications. For example, customer importance data can supplement an application used to ship products and modify the warehouse used to ship the product or modify the transmission of a shipping delay message.

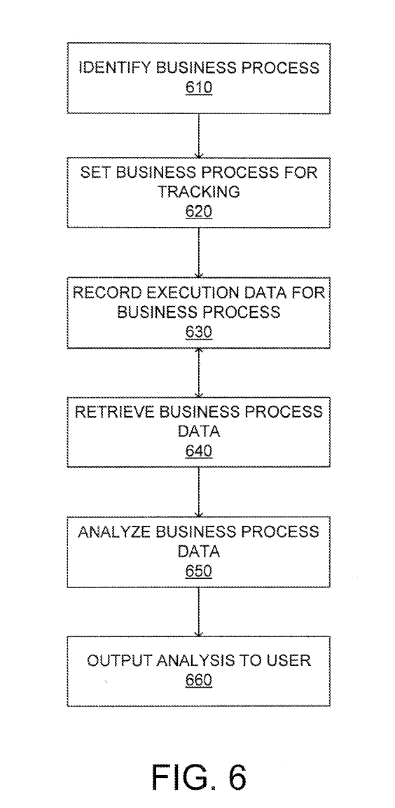

FIG. 6 is a flow chart of a method for business process analysis by identifying a data path, according to an embodiment of the invention.

Initially, a business process is identified 610. In an embodiment, the business process is identified 610 by defining a start point, or start points, and an end point for the business process. For example, a user defines a request for a type of data as the start point and the corresponding receipt of the requested data as the end point. Alternatively, a user defines a step in the retrieval or computation of the requested data as the business process end point. Alternatively, a defined business process is selected from a listing or menu of existing business processes. The identified 610 business process is then set 620 to be tracked. In an embodiment, setting 620 the business process for tracking comprises receiving a user command or indication flagging the business process for tracking. Alternatively, the identified 610 business process is automatically set 620 to be tracked when it is identified 610.

After being set 620 for tracking, data is recorded 630 as the business process executes. As part of the tracking, each server node 110 executing a portion of the business process records 630 data associated with the business process. Thus, each server node 110 records 630 input and/or output data used to execute the business process. Because each server node 110 records 630 business process data, the flow of data through server nodes 110 as the business process executes is identified.

The recorded 630 business process data is then retrieved 640 from the server nodes 110 by an administrator node 120. In an embodiment, the execution data is retrieved 640 in response to a user request. Alternatively, the administrator node 120 retrieves 640 the data according to a predetermined schedule or continuously retrieves 640 the data as it is recorded 630.

After retrieval 640, the business process data is then analyzed 650 by the administrator node 120. For example, the time needed to complete the business process is computed, the operation time of each step in the business process is computed, the relative time of each step in the business process is computed, a performance indicator is calculated, a calculated performance indicator is compared to a benchmark or other suitable analysis 650 is performed. In an embodiment, a user defines the type of analysis 650 to perform and/or selects the portions of the business process to analyze 650. The results of the analysis 650 are then output 660 to the user. In an embodiment, a graphical user interface (GUI) is used to output 660 the analysis results using images, text or a combination of images and text. Alternatively, the analysis 650 results are output 660 to the user by printing a report, emailing a report to a user, displaying the results on a web site or other suitable form of data presentation. In an embodiment, the analysis 650 is completed before being output 660. Alternatively, the output 660 comprises a real-time display of the analysis 650.

User Interface

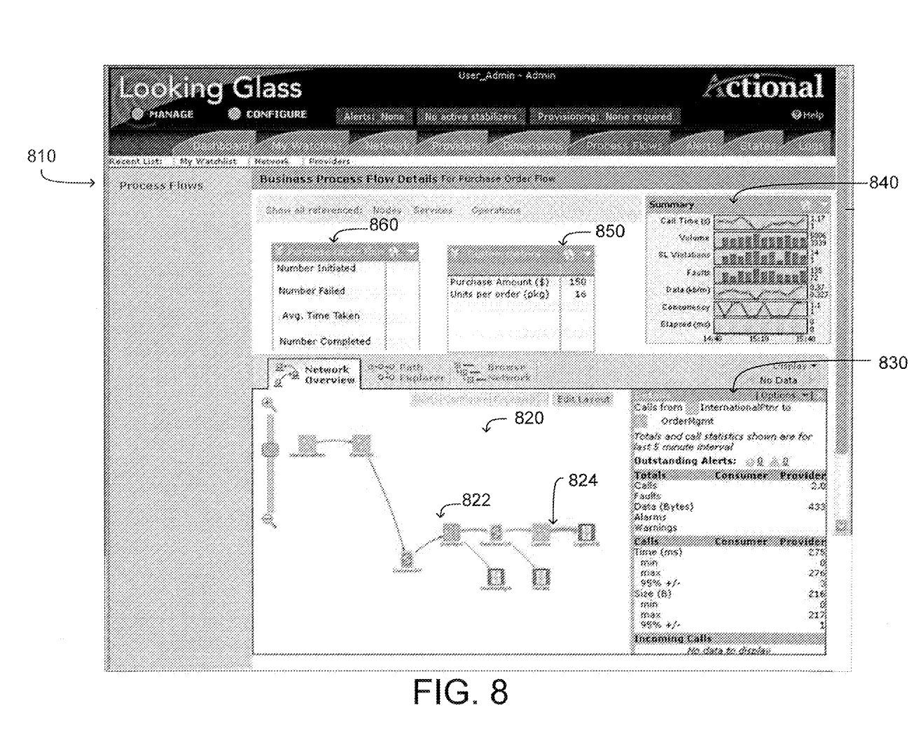

FIG. 8 illustrates a user interface for analyzing a business process according to an embodiment of the present invention. Those of skill in the art will recognize that different embodiments can provide the information and functionality of FIG. 8 in different ways. Moreover, other embodiments can include different and/or additional features and/or layouts than the ones described here. In an embodiment, a display area 810 is partitioned into multiple sections each displaying different data related to the business process.

In one embodiment, a process overview section 820 displays a graphical representation of a selected business process. Node icons 822 represent the different server nodes 110 that execute the business process, with connectors 824 illustrating the data flow between the node icons 822. The combination of node icons 822 and connectors 824 shows the flow of data between server nodes 110 while the selected business process is executed. In an embodiment, the connectors 824 are displayed in a visually distinct manner, such as using color, line thickness, line type or other suitable visual indications to depict the data flow between server nodes 110. For example, the thickness of the connectors 824 increases to show increased data flow between server nodes 110 and decreases to show reduced data flow between server nodes 110.

A process detail section 830 displays data describing the execution of a segment of the business process, allowing different segments of the business process to be analyzed. A segment comprises a user-defined number of node icons 822 and connectors 824, representing execution of a part of the business process. In an embodiment, a user defines analyzed segment by selecting a starting node icon 822 and an ending node icon 822 from the business process overview section 820. In an embodiment, the user selects a starting node icon 822, corresponding to a starting server node 110, and an ending node icon 822, corresponding to an ending server node 110, from the process overview section 820.

In an embodiment, selection of the starting node icon 822 and the ending node icon 822 causes additional data (e.g. call start time, call processing time, call size, etc.) to be recorded and stored from the corresponding server nodes 110. This additional data is then analyzed and presented to the user in process detail section 830. Alternatively, the starting server node 110 and the ending server node 110 names are then used to generate a path identifier for the data path between starting server node 110 and ending server node 110. Calls between the starting server node 110 and the ending server node 110 are then retrieved and analyzed, with results such as total calls, total data, average call time, average call size, or other suitable data indicating the performance of the business process segment displayed in process detail section 830. In an embodiment, the user also specifies a time interval over which the business process segment is analyzed, allowing analysis of performance changes.

A summary section 840 displays graphical data showing the performance of the business process or a portion of the business process. In the example of FIG. 8, call time, call volume, data rate and/or other user-definable information are shown for a specified time interval. In an embodiment, a user selects the information presented in the summary section 840, allowing customized analysis of the business process based on user-specific concerns or requirements. In an embodiment, the summary section 840 updates the graphical data as the business process executes, providing a real-time display of business process performance. Alternatively, the summary section 840 updates the graphical data at specified intervals to show average execution performance over the specified interval.

A custom value section 850 displays flow field data which is transmitted along the business process. Thus, the custom value section 850 allows the user to track the value of certain data fields throughout the business process. The user selects the data fields for display in the custom value section 850, allowing display of different data used during the business process execution. In the example shown in FIG. 8, the “Purchase Amount($)” and “Units per order (pkg)” fields of the illustrated business process have been selected for analysis. As these fields change during business process execution, the custom value section 850 section is updated to show the current field values.

A process data section 860 describes overall performance of the business process. In an embodiment, the process data section 860 displays the number of times the process is initiated, the number of times the business process fails to fully execute, the average time to complete the business process, the number of times the business process is successfully completed, or any other measurable data or statistics. The user defines the information displayed in the process data section 860 by selecting predetermined data computations or by defining user-specific computations based on the measured data. In an embodiment, the process data section 860 is updated in real-time to display the current status of the business process. Alternatively, the process data section 860 is updated at defined intervals to provide a periodic status report of the business process. In an embodiment, the user selects the data tracked and displayed in the process data section 860. Examining the process data section 860 allows a user to evaluate the overall performance of the business process as a whole.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the invention. This is done merely for convenience and to give a general sense of the invention. This description should be read to include one or at least one and the singular also includes the plural unless it is obvious that it is meant otherwise.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats. Furthermore, as will be apparent to one of ordinary skill in the relevant art, the modules, routines, features, attributes, methodologies and other aspects of the present invention can be implemented as software, hardware, firmware or any combination of the three. Of course, wherever a component, an example of which is a module, of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

What is claimed is:

1. An apparatus for identifying a data processing path of a distributed network comprising:
an application for receiving and processing input data and generating output data;
an intercept module, adapted to communicate with the application, for intercepting a portion of the input data and for intercepting a portion of the output data; and
an agent module, adapted to communicate with the intercept module, for storing the intercepted portion of the input data and the intercepted portion of the output data and for generating a path identifier uniquely identifying the intercepted portion of the input data and an intercepted portion of the output data corresponding to the intercepted portion of the input data.

2. The apparatus of claim 1, further comprising:
a communication module adapted to communicate with the intercept module, the communication module for receiving data and for transmitting data from the intercept module.

3. The apparatus of claim 2, wherein the communication module is further adapted to communicate with the agent module, wherein the communication module transmits data from the agent module to a second apparatus.

4. The apparatus of claim 1, wherein the agent module compresses the intercepted portion of the input data and the intercepted portion of the output data.

5. The apparatus of claim 1, wherein the agent module comprises:
a temporary table for storing an intercepted input data without an intercepted output data corresponding to the input data.

6. The apparatus of claim 5, wherein the agent module further comprises:
a permanent table for storing the intercepted input data and the intercepted output data corresponding to the input data

7. The apparatus of claim 1, wherein the agent module generates the path identifier by applying a hash function to a portion of the intercepted portion of the input data and the intercepted portion of the output data corresponding to the input data.

8. The apparatus of claim 1, wherein the intercept module comprises:
an inbound intercept module, adapted to communicate with the application, for intercepting the portion of the input data and transmitting the input data to the application; and
an outbound intercept module, adapted to communicate with the application, for intercepting the portion of the output data received from the application.

9. A method for identifying a data processing path in a distributed computing network, the method comprising:
identifying a call which transmits data to a remote device;
generating a path identifier for uniquely identifying the data processing path associated with the identified call;
associating the path identifier with the call;
storing data associated with the identified call;
storing the generated path identifier; and
correlating the stored path identifier with the stored data associated with the identified call.

10. The method of claim 9, further comprising:
sorting the stored data based on the associated generated path identifier.

11. The method for claim 9 wherein generating a path identifier comprises:
applying a hash function to a portion of the data included in the data processing path.

12. The method of claim 11, wherein the portion of the data included in the data processing path comprises: a node name and an operation identifier.

13. The method of claim 12, wherein the portion of the data included in the data processing path further comprises: a path identifier identifying an originating path of the call.

14. The method of claim 9 further comprising:
transmitting the call to the remote device; and
transmitting the generated path identifier to the remote device.

15. The method of claim 9, wherein associating the path identifier with the call comprises:
storing a call identifier associated with the path identifier.

16. The method of claim 9, further comprising:
transmitting the call to the remote device, wherein the remote device associates the call with the path identifier.

17. A method for adding data to a data processing path in a distributed computing network, the method comprising:
selecting, at an administrative node, a data path;
selecting, at the administrative node, a flow field, the flow field comprising data to be transmitted throughout the data path; and
transmitting the flow field from the administrative node to a first server node for transmission to additional server nodes.

18. The method of claim 17, further comprising:
transmitting the flow field from the first server node to a second server node.

19. The method of claim 17, further comprising:
generating, at the administrative node, a path identifier, the path identifier uniquely identifying the data path; and
transmitting the path identifier from the administrative node to a first server node for transmission to additional server nodes.
